(19) United States
(12) Patent Application Publication
(10) Pub. No.: US 2026/0066258 A1
(43) Pub. Date: Mar. 5, 2026

(54) STORAGE DEVICE AND MANUFACTURING METHOD

(71) Applicant: COMMISSARIAT A L'ENERGIE ATOMIQUE ET AUX ENERGIES ALTERNATIVES, Paris (FR)

(72) Inventors: Jacopo CELE, Grenoble Cedex 09 (FR); Jean-Philippe COLONNA, Grenoble Cedex 09 (FR); Elisabeth JACQUIN, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 19/316,123

(22) Filed: Sep. 2, 2025

(30) Foreign Application Priority Data
Sep. 2, 2024 (FR) FR2409338

(51) Int. Cl. H01M 4/04; H01G 11/26; H01M 4/525

(52) U.S. Cl. CPC H01M 4/0404; H01M 4/0423; H01M 4/045; H01M 4/0471; H01M 4/525; H01G 11/26

(57) ABSTRACT

A method for producing an electrode of a solid battery including at least the following steps: a production of an electrode on a support, the electrode having an upper face opposite the support, the electrode having at least one cavity extending in a hollow section from its upper face, a formation of an ionically insulating layer, called barrier layer, on the upper face of the electrode and in the at least one cavity, then a removal of the barrier layer, so as to expose the upper face of the electrode, while leaving in place the portion of the barrier layer extending into the at least one cavity.

### TECHNICAL FIELD

The present invention relates to microelectronic devices having electrodes, in the field of electrochemical energy storage, in particular in the form of microbatteries (thus producing an electrochemical microstorage component). The invention applies to the manufacture of microelectronic devices offering such a storage. By microelectronic device, this means any type of device produced with microelectronic means. These devices include, in particular, in addition to devices with a purely electronic purpose, micromechanical or electromechanical devices (MEMS, NEMS, etc.), as well as optical or optoelectronic devices (MOEMS, etc.). This includes applications of the electrochemical microstorage component type (microbatteries, microsupercapacitors, solid ion components of any type).

A specific interest of the invention is therefore the production of electrochemical energy storage devices. This includes, in particular, devices of the battery type, and in particular, those on the microelectronic scale, called microbatteries, accumulators or capacitors using an electrolyte, preferably solid.

### PRIOR ART

Electrochemical energy storage systems are generally produced by successive depositions on a substrate of a first current collector, of a first electrode, or an electrolyte or ion conductor, of a second electrode, and of a second current collector. An encapsulation, through the deposition of additional layers, or by cover transfer, is often necessary to protect the system from chemical reactivity with oxygen and water vapour.

The miniaturisation of devices involves being able to produce small energy sources, in particular, of a few square centimetres, capable of storing a sufficient energy quantity for the application. The capacity of a microbattery is directly proportional to the volume of the two electrodes, and in particular, of the positive electrode. The active surface of the latter is highly limited by the final size of the microbattery, such that it can be integrated to the final device, without a size which is too disadvantage. Thus, a usable way to increase the capacity of a battery, while minimising its size is to increase the thickness of the electrode, and in particular, of the positive electrode. It is typically sought to exceed a thickness of 10 μm.

However, increasing this thickness leads to surface defects linked to the deposition method, being able to lead to the short-circuiting of the energy storage device. In particular, the electrode materials like LiCoO₂ are usually deposited by cathode sputtering methods, which are limited to low thicknesses, generally less than ten micrometres.

An attempt of a solution to the problem stated above is proposed in publication US 2021/0359339 A1, which proposes to perform a polishing of the upper face of the electrode. However, this solution is not satisfactory, as when surface defects extend very deeply into the electrode, the polishing must be effective over this same depth. This leads to a very high reduction of the thickness of the electrode, which is counterproductive in an aim to increase the capacity of the battery.

An aim is therefore to propose an electrode manufacturing method, enabling significant thicknesses without this being very damaging, even not damaging, to the performance of the electrode, even advantageous, especially from an electrical point of view.

Other aims, features and advantages will appear upon examining the description below and the accompanying drawings.

### SUMMARY

To achieve this aim, a first aspect of the invention relates to a method for producing an electrode of a solid battery comprising at least the following steps:
a. a production of an electrode on a support, the electrode having an upper face opposite the support, the electrode having at least one cavity extending from its upper face,
b. a formation of an ionically insulating layer, called barrier layer, on the upper face of the electrode and in the at least one cavity,
c. a removal of the battery layer, so as to expose the upper face of the electrode, while leaving in place the portion of the barrier layer extending into the at least one cavity.

The portion of the barrier layer left in place at the at least one cavity thus separates the electrode and the electrolyte at this cavity. It thus ensures a local ion insulation between these two layers. This makes it possible to limit, even prevent, short-circuits within a storage system comprising the electrode formed by the method described above. It is observed, in particular, that this local ion insulation makes it possible to avoid the appearance of high-concentration zones of the electrical field during the operation of the storage system, zones which are very damaging to the performance of the system. The barrier layer makes it possible, at the same time, to avoid the materials forming the electrolyte and the electrode from cracking under the effect of these high currents.

The local ion insulation between the electrode and the electrolyte is moreover only effective at the cavities, the ion current thus being able to circulate between these two layers at the entire rest of the upper face of the electrode. It is thus estimated that the exchange surface between the electrode and the electrolyte lost due to the ion insulation represents less than 5% of the total surface. This proportion is absolutely acceptable, in particular once taken as regards the advantages that the insulation provides.

Moreover, the solution proposed does not require to decrease the thickness of the electrode, as is the case in the current solutions (US 2021/0359339 A1, in particular). It is possible that a low thickness of the electrode is removed during the partial removal of the barrier layer, but this thickness is very low, relative to the total thickness of the electrode. It is, in particular, not necessary in the method according to the invention to remove the electrode over the thickness over which the cavities extend. The thickness of the electrode is thus very highly, even fully preserved, which is beneficial to the capacity of the storage system.

A second aspect of the invention relates to a method for manufacturing an electrochemical energy storage device, comprising the production of at least one electrode by implementing the method according to the first aspect of the invention.

A third aspect of the invention relates to an electrochemical energy storage device, comprising, in a stack on a support, a collector, an electrode and an electrolyte, in which the electrode comprises at least one cavity formed in a hollow section from an upper face of the electrode, and in that an ionically insulating layer, called barrier layer, fills at least partially the at least one cavity, the barrier layer thus locally separating the electrode and the electrolyte.

The advantages and technical effects described in reference to the method according to the first aspect of the invention apply mutatis mutandis to the method and to the device according to the second and third aspects of the invention.

### BRIEF DESCRIPTION OF THE FIGURES

The aims, objectives, as well as the features and advantages of the invention will best emerge from the detailed description of an embodiment of the latter, which is illustrated by the following accompanying drawings, in which:

FIGS. 1A and 1B represent the growth of a defect during the formation of an electrode.

FIG. 1C is an image obtained by scanning electron microscope (SEM) of defects typically appearing during the growth of an electrode.

FIG. 2A illustrates the formation of a cavity in an electrode following the loosening of a defect.

FIG. 2B illustrates the concentration of the electrical field at the cavity during the operation of an energy storage system comprising the electrode of FIG. 2A.

FIGS. 3A to 3F illustrate the different steps of an example of a method according to the present invention.

FIG. 4A is a magnification of FIGS. 3C and 3D on the upper face of the electrode.

FIG. 4B is a magnification of FIG. 3F on the upper face of the electrode.

FIGS. 5A to 5C illustrate an alternative embodiment in which the particles present in the cavities on the surface of the electrode are removed.

The drawings are given as examples, and are not limiting of the invention. They constitute principle schematic representations, intended to facilitate the understanding of the invention, and are not necessarily to the scale of practical applications. In particular, the dimensions are not representative of reality.

### DETAILED DESCRIPTION

Before starting a detailed review of the embodiments of the invention, optional features are stated below, which can optionally be used in association or alternatively:

According to an embodiment, the electrode is produced by physical vapour deposition or by electrochemical deposition.

According to an example, LiCoO₂ is used to produce the electrode.

According to a preferred embodiment, the method further comprises, before the step of forming the barrier layer, a step of annealing the electrode. This annealing step makes it possible to remove at least some of the particles located in the cavities. Such an annealing makes it possible, in particular, to remove with a good effectiveness, the largest particles, which are the most obstructive. Advantageously, the annealing is done at a temperature greater than or equal to 300° C., for example, at a temperature substantially equal to 400° C. Alternatively, or combined with the annealing step, the removal of the particles can be done with using ultrasound and/or a mechanical action. This mechanical action can, for example, be performed by a scrubber), using jets or brushes.

According to a preferred embodiment, the method further comprises, before the step of forming the barrier layer, a step of polishing the electrode from its upper face. The polishing makes it possible to make the particles located in the cavities come loose.

According to an example, the polishing step is configured to taper the electrode over a thickness greater than or equal to 100 nm, preferably greater than or equal to 500 nm, and/or less than or equal to 2 μm. For example, over a thickness substantially equal to 1 μm.

According to a preferred embodiment, the step of removing the barrier layer comprises at least one from among a chemical-mechanical polishing step and a grinding step.

According to a preferred embodiment, the step of removing the barrier layer comprises the following steps:
a. a deposition of a resin layer on the barrier layer, the portions of the resin layer surmounting the at least one cavity having a thickness greater than that of the portions of the resin layer not surmounting the at least one cavity,
b. an etching of the resin layer and of the barrier layer, so as to expose the upper face of the electrode, while leaving in place the portions of the barrier layer extending into the at least one cavity.

According to an example, the deposition of the resin layer is configured, such that this has a thickness less than or equal to 2 micrometres in its portions not surmounting the at least one cavity.

According to an example, the barrier layer has a thickness greater than or equal to 10 nm, preferably greater than or equal to 30 nm.

According to an example of the method for manufacturing a chemical energy storage device according to the invention, the latter further comprises a formation of a collector on a support, then the production of the electrode on the collector.

Certain parts of the device of the invention can have an electrical function. Some are used for ion conduction properties, and by electrode, collector or equivalent, this means elements formed of at least one material having a sufficient ion conductivity, in the application, to perform the desired function. Conversely, by ion or dielectric insulator, this means a material which, in the application, ensures an ion insulation function.

By electrochemical energy storage device, this means a device operating with an electrolyte layer, preferably in solid form, and enabling, in conjunction with a lower ionically conductive operational part and an upper ionically conductive operational part, surrounding the electrolyte layer, the energy storage in the form of a potential difference increase or the energy release in the form of a potential difference reduction. In the field of microelectronics, these can be microbatteries, which mean such devices with dimensions on a microelectronic scale, in particular with an overall thickness of a few tens of microns, for example, less than 100 micrometres.

Generally, an electrochemical energy storage device comprises two electrodes separated by an electrolyte. During discharge, the anode (negative electrode) is the seat of an oxidation, ions pass through the electrolyte, and go to the cathode (positive electrode) undergoing a reduction and being inserted in a specific material (host material); the electrons thus produced supply the outer circuit with energy. During charging, the ions go in the opposite direction, the electrons being supplied by the outer circuit.

By “selective etching opposite” or “etching having a selectivity opposite”, this means an etching configured to remove a material A or a layer A opposite a material B or a layer B, and having an etching speed of the material A greater than the etching speed of the material B. The selectivity is the ratio between the etching speed of the material A over the etching speed of the material B. The selectivity between A and B is referenced SA:B.

It is specified that, in the scope of the present invention, the terms “on”, “surmounts”, “covers”, “underlying”, “opposite” and their equivalents do not necessarily mean “in contact with”. Thus, for example, the deposition, the transfer, the bonding, the assembly or the application of a first layer on a second layer, does not compulsorily mean that the two layers are directly in contact with one another, but means that the first layer covers at least partially the second layer by being, either directly in contact with it, or by being separated from it by at least one other layer or at least one other element.

A layer can moreover be composed of several sublayers of one same material or of different materials.

By a substrate, a layer, a device “with the basis” of a material M, this means a substrate, a layer, a device comprising this material M only or this material M and optionally other materials, for example, alloy elements, impurities or doping elements.

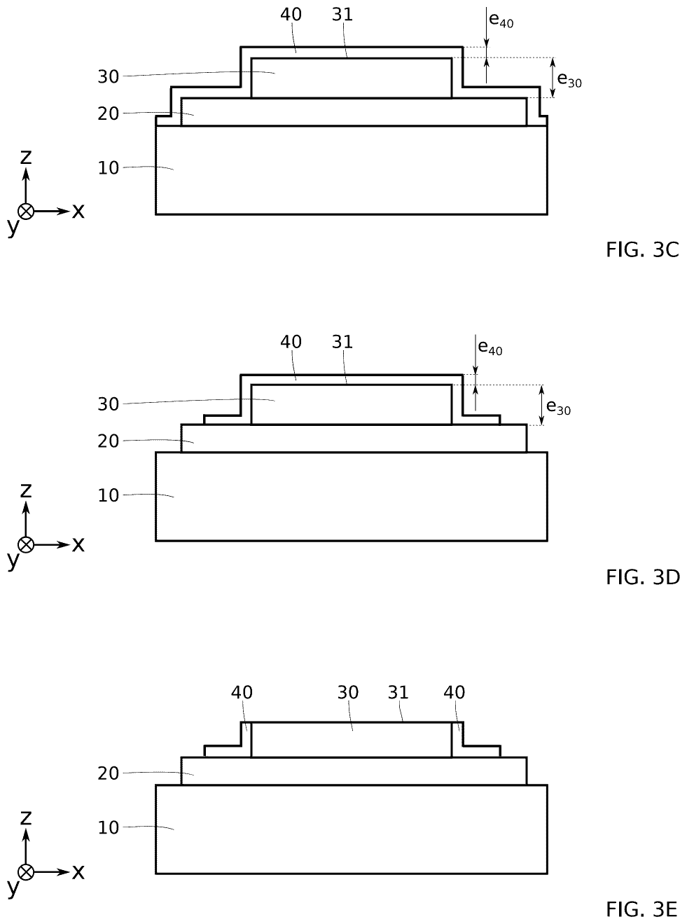

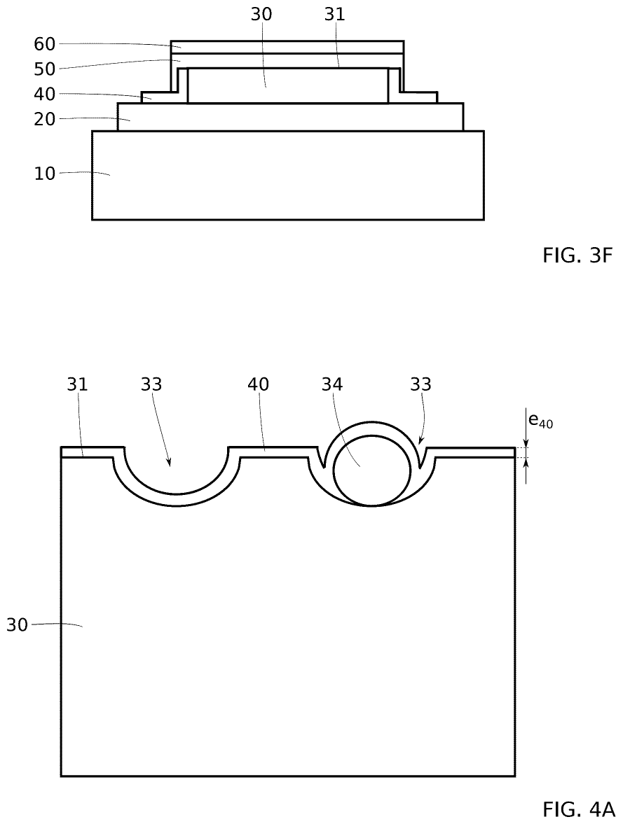

A preferably orthonormal system, comprising the axes X, Y, Z is represented in FIG. 3A. This system is applicable by extension to the other figures.

In the present patent application, thickness will preferably be referred to for a layer, and height will preferably be referred to for a structure or a device. The height is taken perpendicularly to the transverse plane XY. The thickness is taken along a direction normal to the main extension plane of the layer. Thus, a layer typically has a thickness along Z, when it extends mainly along the transverse plane XY, and a projecting element, for example, a trench, has a height along Z. The relative terms “on”, “under”, “underlying” preferably refer to positions taken along the direction Z.

The terms “substantially”, “around”, “about” mean “plus or minus 10%, preferably 5%”.

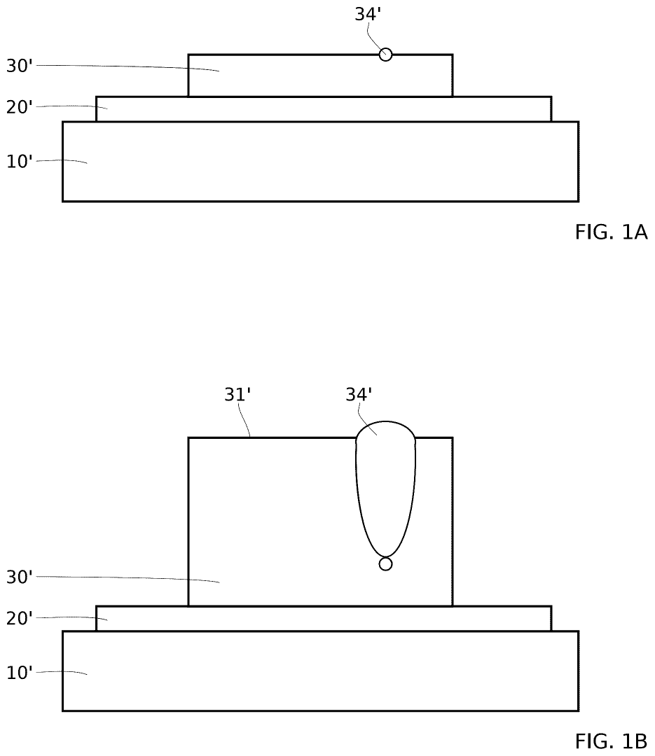

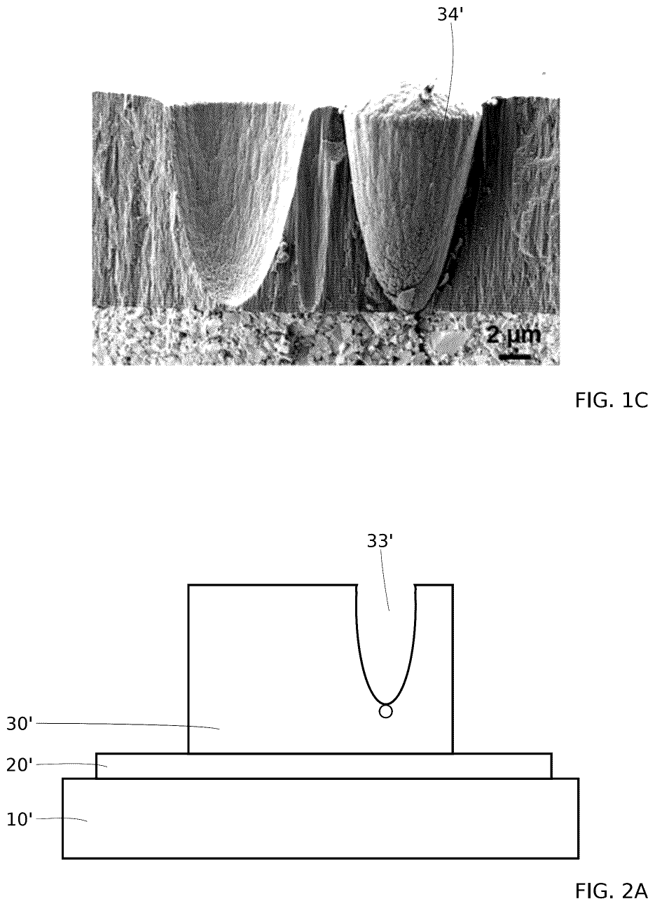

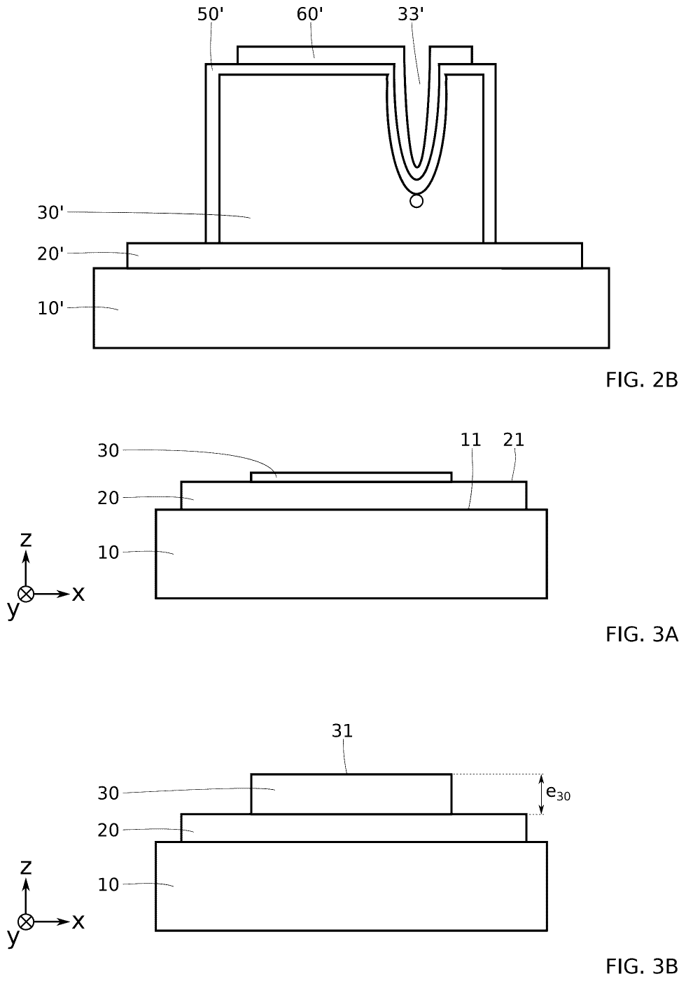

FIGS. 1A to 2B illustrate the disadvantages of the prior art. More specifically, FIG. 1A represents the start of the formation of an electrode 30′ on a stack formed of a support 10′ and of a collector 20′. As illustrated, absolutely conventionally, at least one defect 34′ appears during the deposition of the electrode 30′. During the deposition of the electrode 30′, this defect 34′ grows and finishes by extending up to the upper face 31′ of the electrode 30′. An SEM view of such a defect 34′ is presented in FIG. 1C extracted from the publication, Influence of Growth Defects on the Corrosion Resistance of Sputter-Deposited TiAlN Hard Coatings, Panjan et al, Coatings 2019. As expressed above, such a defect 34′ can lead to the short-circuiting of the energy storage device. It is noted, in particular, that these defects can appear a lot earlier in the growth of the electrode, and therefore extend over a very large part of the height of the electrode, which is very damaging and encourages short-circuits.

Moreover, as illustrated in FIG. 2A, the defects 34′ can be removed by a voluntary external intervention or be disconnected from themselves, under the effect, for example, of one or more method steps. This creates a cavity 33′, typically having a very high height/width display aspect ratio. After formation of an electrolyte 50′ and of a second electrode 60′ on the upper face of the electrode 30′ and in the cavity 33′, it is observed that the electrical field is very highly concentrated at the bottom of the cavity 33′. This is very damaging for the operation of the storage system and can, in particular, induce short-circuits In particular, this phenomenon can induce the formation of dendrites, for example, of lithium, in the electrolyte, which leads to a short-circuit.

It is these disadvantages that the present invention seeks to limit, even remove.

Different embodiments of the method according to the invention will now be described in reference to FIGS. 3A to 5C.

A support 10 is first provided. This support 10 has an upper face 11, extending mainly into a plane parallel to a transverse plane XY. The transverse plane XY is defined by a first direction X and a second direction Y. The support 10 is, for example, formed with a plate of a semiconductive material, such as silicon or any other organic or inorganic material, for example, glass. If the support 10 is electrically conductive, it can comprise at least one superficial, electrically insulating layer.

Conventionally, a collector 20 is then formed on the upper face 11 of the support 10. In the sense of the present application, the term “collector” means a part of the device having the function of connecting an electrode to an element external to the device, i.e. located outside of the stack of layers of the device, generally encapsulated. Metals with good electricity conduction properties for this part can be used. This is the case for platinum; less expensive materials, like titanium, are also possible.

An electrode 30 is formed on the upper face 21 of the collector, opposite the support 10 (see FIG. 3A). The electrode is, for example, made of LiCoO₂ (cobalt and lithium dioxide). The electrode 30 is typically formed by physical vapour deposition (PVD) or by electrochemical deposition (ECD). The passage from FIG. 3A to FIG. 3B illustrates the progressive formation of the electrode by one of these methods. The different deposition methods which can be considered all lead to a significant surface roughness of the electrode 30.

The electrode 30 has an upper face 31 opposite the support 10 and the collector 20. This typically extends into a plane parallel to the transverse plane XY.

It is understood that FIG. 3B, in particular, is a schematic representation, not showing, in particular, the defects present at the upper face of the electrode 30.

The electrode 30 has a thickness e₃₀ measured perpendicularly to its upper face 31, and therefore typically along the direction Z. The thickness e₃₀ of the electrode is typically greater than 10 μm, preferably greater than 20 μm. It can, in particular, be of between 20 and 200 μm.

As illustrated in FIG. 3C, a layer with the basis of an ionically insulating material is formed on the upper face 31 of the electrode 30. This layer can, in particular, be called barrier layer 40. It can, for example, be with the basis of at least one from among the following materials: Al₂O₃, TiO₂, TiN, Ti, Al, Pt, SiN, SiON, TaN, Ta.

Typically, the barrier layer 40 is deposited evenly on the stack. Thus, initially, the barrier layer 40 is typically deposited on the upper face 21 of the collector 20 and the upper face 11 of the support 10, due to the removal of the electrode 30 relative to the collector 20 and of the collector 20 relative to the support 10. It is thus possible, as illustrated in FIG. 3D, to remove a part of the barrier layer 40, for example, the portion extending against the upper face 11 of the support 10. Advantageously, this removal makes it possible to update at least one portion of the upper face 21 of the collector 20.

The barrier layer 40 has a thickness e₄₀ measured perpendicularly to the upper face 31 of the electrode 30, and therefore typically along the direction Z. The thickness e₄₀ of the barrier layer 40 is typically greater than 10 nm, for example, substantially equal to 50 nm.

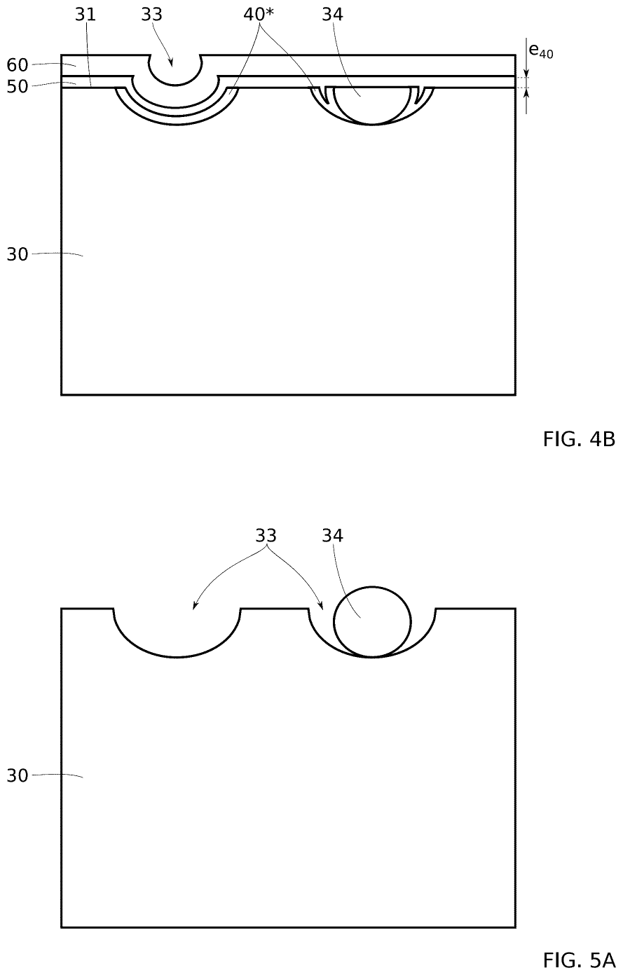

FIG. 4A is a magnification of FIGS. 3C and 3D at the upper face 31 of the electrode 30. It illustrates the defects present on the surface of the electrode 30. As illustrated, cavities 33 extend from the upper face 31 of the electrode 30. These cavities 33 define hollow sections in the electrode 30. In certain cavities 33, additional defects can be found in the form of particles 34.

As illustrated, the deposition of the barrier layer 40 is configured, such that this extends into the cavities 33. The barrier layer 40 moreover covers the particles 34 when these are present in the cavities 33. A deposition of the barrier layer by atomic layer deposition (ALD) is favoured, which enables an even deposition to the bottom of the cavities 33, even when these have a high height/width display aspect ratio.

The barrier layer 40 is then partially removed, so as to update partially, and preferably fully, the zones of the upper face 31 of the electrode 30 with no cavities 33. During this removal, a portion of the barrier layer 40 is kept in place, extending into the cavity(ies) 33. Thus, the portion of the barrier layer 40 maintained in place during this partial removal step, called remaining barrier portion 40*, can be continuous (in the case of one single cavity present on the surface of the electrode 30) or discontinuous (in the case of several cavities). In the latter case, the remaining barrier portion 40* is formed of a plurality of portions, each extending into a cavity 33. Advantageously, the remaining barrier portion 40* fully covers each cavity 33.

The partial removal of the barrier layer 40 can be done in different ways.

According to an example, this removal is done by polishing, for example, by chemical-mechanical polishing (CMP), or by grinding. The polishing can be effective on a thickness greater than the thickness of the barrier layer 40 and continue in the electrode. The polishing can, for example, be done on a thickness of 100 nm. However, it is noted that it is sufficient that the polishing makes it possible to update the upper face 31 of the electrode 30.

According to another example, the removal of the barrier layer 40 is done by unevenly depositing a resin layer on the barrier layer 40, then by performing an etching of the barrier layer 40 through this resin layer. The resin layer is thus deposited, such that it has a first thickness at its portions not surmounting cavities 33 and a second thickness distinct from the first thickness at its portions surmounting the cavities 33. The deposition of the resin layer is configured, such that the second thickness is greater than the first thickness, for example, at least twice greater than the first thickness. For example, the first thickness can be less than or equal to 2 μm and the second thickness greater than or equal to 4 μm. Then, an etching step is carried out, configured to stop when the first thickness is fully removed, and when the upper face 31 of the electrode 30 is updated. With the second thickness being greater than the first thickness, the zones of the barrier layer 40 are located in the cavities 33 are not started by the etching. Stopping this etching can be a simple stopping to time, or the etching can be a selective etching opposite the material of the electrode.

It can be considered to combine these different removal techniques.

Thus, the stack illustrated in FIG. 3E is obtained.

As illustrated in FIG. 3F, conventionally, an electrolyte 50 and a second electrode 60 are then formed above the electrode 30. The electrolyte 50 can, for example, be made of an amorphous nitrided lithium phosphate (LiPON). The second electrode 60 can, for example, be made of titanium. The second electrode, in this case, forms the anode, the cathode being formed by the electrode 30.

The remaining barrier portion 40* thus separates the electrode 30 and the electrolyte 50 at each cavity 33. It thus ensures a local ion insulation between these two layers. This makes it possible to limit, even prevent, short-circuits within the storage system.

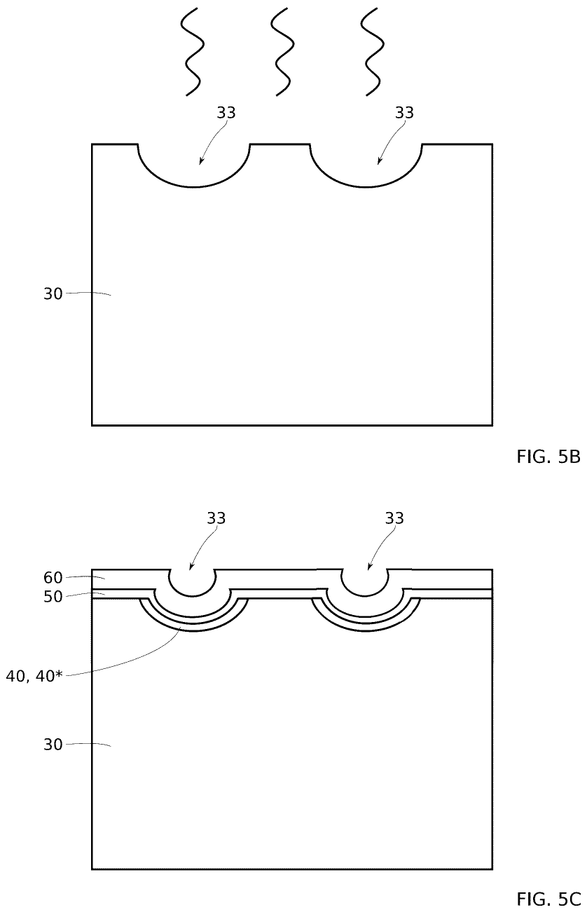

FIGS. 5A to 5C illustrate an advantageous embodiment of the method according to the invention. In this example, the removal of the particles 34 located in the cavities 33 is proceeded with, before forming the barrier layer 40.

It has indeed been noted that, during the partial removal of the barrier layer 40, the particles 34 present in the cavities 33 sometimes loosened. With the barrier layer 40 having been deposited on these particles 34, the loosening of these particles generates the local absence of barrier layer at the bottom of the cavities 33. The insulation is therefore no longer locally ensured in the cavities 33, in which a particle 34 was present, then loosened. To prevent this, a step of removing at least some of the particles 34 is advantageously provided, before the step of depositing the barrier layer 40.

To do this, it is, for example, possible to perform an annealing of the electrode (FIG. 5B). This annealing generates stresses in the particles 34 and the electrode 30 finishing by generating the detachment of the particles 34. This method will operate particularly well in the case of an electrode formed in a high thermal dilatation coefficient material, as is, in particular, the case for LiCoO₂.

It is also possible to implement a polishing step, which also has the effect of detaching the particles 34. This polishing can, for example, be done over a thickness less than or equal to 1 μm.

Annealing and polishing can naturally be combined to detach as many particles 34 as possible.

It is noted that an annealing step can be sufficient to remove the most obstructive particles 34 for the operation of the storage system, i.e. those having the largest dimensions. Generally, it is estimated that a particle 34 having a height less than or equal to 50% of the height of the electrode 30 is not obstructive.

Another aim of the invention relates to an electrochemical energy storage device. This device is illustrated in FIG. 3F. It comprises, in a stack: the support 10, the collector 20, the electrode 30 and the electrolyte 50. As described above, the electrode 30 has at least one cavity 33 extending from its upper face 31. Moreover, the device according to the invention comprises the remaining barrier portion of the barrier layer such as described above, and which thus separates, at the cavities 33, the electrode 30 and the electrolyte 50. This storage device can be obtained by having implemented any one of the embodiments of the method described above. In particular, the particles 34 present at the cavities 33 can, or not, have been removed during the manufacture of the device. The final device can therefore, or not, have residues of particles 34, even entire particles within the cavities 33 (magnifications of FIG. 4B or 5C).

In view of the different embodiments described above, it appears that the present invention proposes an effective solution to improve the performance of an electrode, in particular, within an electrochemical energy storage device. In particular, the invention limits the problems of short-circuits and of cracks in the electrolyte and in storage systems in general, and makes it possible that the electrode has a high thickness (several tens, even hundreds of micrometres). This is conveyed by an improvement of the storage capacity of the system, and therefore a more efficient system.

The invention is not limited to the embodiments described above, and extends to all the embodiments covered by the invention.

1. A method for producing an electrode of a solid battery comprising at least the following steps:
a production of an electrode on a support, the electrode having an upper face opposite the support the electrode having at least one cavity extending in a hollow section from its upper face, the at least one cavity having appeared following a removal of a particle formed during the production of the electrode,
a formation of an ionically insulating layer, called barrier layer, on the upper face of the electrode and in the at least one cavity,
a removal of the battery layer, so as to expose the upper face of the electrode, while leaving in place the portion of the barrier layer extending into the at least one cavity.

2. The method according to claim 1, wherein the electrode is produced by physical vapour deposition or by electrochemical deposition.

3. The method according to claim 1, wherein LiCoO₂ is used to produce the electrode.

4. The method according to claim 1, further comprising, before the step of forming the barrier layer, a step of annealing the electrode. claim 1, further comprising, before the step of forming the barrier layer, a step of polishing the electrode from its upper face.

6. The method according to claim 5, wherein the polishing step is configured to taper the electrode over a thickness greater than or equal to 100 nm and/or less than or equal to 2 μm.

7. The method according to claim 1, wherein the step of removing the barrier layer comprises at least one from among a chemical-mechanical polishing step and a grinding step.

8. The method according to claim 1, wherein the step of removing the barrier layer comprises the following steps:
a deposition of a resin layer on the barrier layer, the portions of the resin layer surmounting the at least one cavity having a thickness greater than that of the portions of the resin layer not surmounting the at least one cavity,
an etching of the resin layer and of the barrier layer, so as to expose the upper face of the electrode, while leaving in place the portions of the barrier layer extending into the at least one cavity.

9. The method according to claim 8, wherein the deposition of the resin layer is configured, such that this has a thickness less than or equal to 2 micrometres in its portions not surmounting the at least one cavity.

10. The method according to claim 1, wherein the barrier layer has a thickness greater than or equal to 10 nm.

11. The method for manufacturing an electrochemical energy storage device, comprising the production of at least one electrode by implementing the method according to claim 1.

12. The method according to claim 11, comprising a formation of a collector on the support, then the production of the electrode on the collector.

13. An electrochemical energy storage device, comprising, in a stack on a support, a collector, an electrode and an electrolyte, wherein the electrode comprises at least one cavity formed in a hollow section from an upper face of the electrode, and wherein an ionically insulating layer, called barrier layer, fills at least partially the at least one cavity, the barrier layer thus locally separating the electrode and the electrolyte.
